(19) United States
(12) Patent Application Publication
(10) Pub. No.: US 2014/0328247 A1
(43) Pub. Date: Nov. 6, 2014

(54) Explicitly Sounding Beyond the Beamformee Sounding Capability

(71) Applicant: CISCO TECHNOLOGY, INC., San Jose, CA (US)

(72) Inventors: Matthew A. Silverman, Shaker Heights, OH (US); Paul J. Stager, Akron, OH (US); David Kloper, Santa Clara, CA (US)

(73) Assignee: Cisco Technology, Inc., San Jose, CA (US)

(21) Appl. No.: 13/874,657

(22) Filed: May 1, 2013

(51) Int. Cl. H04L 25/02

(52) U.S. Cl. CPC H04L 25/0228
USPC 370/328

(57) ABSTRACT

A first device explicitly sounds a wireless channel with respect to a second device even when the second device cannot sound all the antenna/transmit paths of the first device. The first device has a first plurality of antennas and corresponding transmitters and the second device has a second plurality antennas and corresponding receivers. The first device wirelessly transmits a plurality of sounding frames to the second device such that at least one of the first plurality of antennas is kept constant across the plurality of sounding frames. The first device receives from the second device at least one feedback message containing channel matrix information derived from reception of the sounding frames at the second plurality of antennas of the second device. The first device derives a full wireless channel estimate between the first plurality of antennas of the first device and the second plurality of antennas of the second device.

### TECHNICAL FIELD

The present disclosure relates to wireless communication networks and devices.

### BACKGROUND

The IEEE 802.11n and 802.11ac wireless communication standards specify an explicit sounding procedure. This procedure allows for sounding of the nTx_beamformer antennas by nRx_beamformee antennas channel between the beamformer (e.g., an access point) and the beamformee (e.g., a client device).

If the number of antennas on the beamformer is greater than the number of training fields, e.g., number of High-Throughput/Very High-Throughput-Long Training Fields (HT/VHT-LTFs) that the beamformee can resolve, the channel cannot be fully sounded by explicit sounding procedures. The inability to fully sound a channel between the two devices can result in degraded wireless network performance.

### BRIEF DESCRIPTION OF THE DRAWINGS

FIG. 1 is a block diagram illustrating a first device (the beamformer) seeking to explicitly sound a wireless channel to a second device (the beamformee) in situations beyond the sounding capability of the second device.

FIG. 2 is a flow chart depicting operations performed in the first device to explicitly sound the wireless channel to the second device.

FIG. 3 is a flow chart depicting, in more detail, operations performed by the first device when explicitly sounding the wireless channel to the second device.

FIG. 4 is a flow chart depicting operations performed by the device in a further embodiment.

FIG. 5 is an example block diagram of the first device configured to perform the explicit sounding procedures presented herein.

### DESCRIPTION OF EXAMPLE EMBODIMENTS

### Overview

Techniques are presented herein to enable a first device (e.g., an access point or base station) to explicitly sound a wireless channel to a second device (e.g., a client or mobile station) even when the second device cannot sound all the antenna/transmit paths of the first device. The first device has a first plurality of antennas and corresponding transmitters and the second device has a second plurality antennas and corresponding receivers. The first device wirelessly transmits a plurality of sounding frames to the second device such that at least one of the first plurality of antennas is kept constant across the plurality of sounding frames. The first device receives from the second device at least one feedback message containing channel matrix information derived from reception of the sounding frames at the second plurality of antennas of the second device. From the channel matrix information, the first device derives a full wireless channel estimate between the first plurality of antennas of the first device and the second plurality of antennas of the second device.

### Example Embodiments

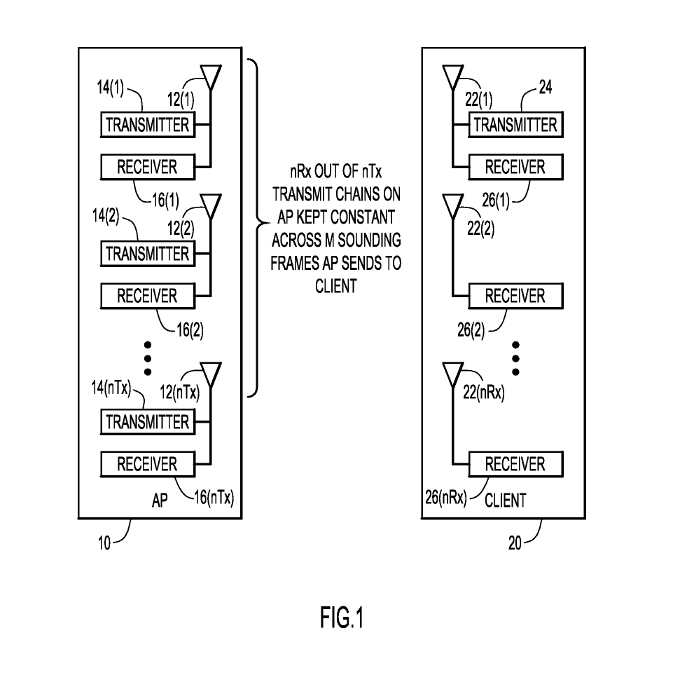

Referring first to FIG. 1, a block diagram is shown of a first device 10, e.g., an access point (AP) and a second device 20, e.g., a client device (client). The first device 10 (the beamformer) is seeking to wirelessly transmit signals to the second device 20 (the beamformee), and to do so, needs to sound the wireless channel between the first device and second device. For simplicity in the following description, the first device 10 is referred to as an AP and the second device 20 is referred to as a client, and in one example, the AP and client operate in accordance with the IEEE 802.11n and/or 802.11ac wireless communication standards. However, these techniques may be employed in other wireless communication systems, such as wireless wide area networks (WWANs), e.g., cellular systems, where the first device is a base station and the second device is a user equipment (handset) or mobile station.

The AP 10 has nTx antennas 12(1)-12(nTx), and connected to each antenna is a transmitter and a receiver. For example, transmitter 14(1) and receiver 16(1) are connected to antenna 12(1), transmitter 14(2) and receiver 16(2) are connected to antenna 12(2), . . . , and transmitter 14(nTx) and receiver 16(nTx) are connected to antenna 12(nTx). Similarly, the client 20 has nRx antennas 22(1)-22(nRx). In the example shown in FIG. 1, the client 20 has a single transmitter 24 connected to antenna 22(1), and nRx receivers 26(1)-26(nRx), such that receiver 26(1) is connected to antenna 22(1), receiver 26(2) is connected to antenna 22(2) and receiver 26(nRx) is connected to antenna 26(nRx).

In order to sound the wireless channel between the AP 10 and the client 20, a sounding scheme is presented that enables explicit sounding beyond the sounding capabilities of the client 20. According to these techniques, nRx (number of) out of nTx transmitters/antennas (hereinafter referred to as “transmit chains”) on the AP 10 are kept constant across M sounding frames (packets) the AP 10 sends to the client 20. In so doing, the full nTx by nRx channel can be well sounded without the client supporting sounding for all nTx High-Throughput/Very High-Throughput-Long Training Fields (HT/VHT-LTFs). Thus, the term “full wireless channel estimate” refers to a nTx×nRx channel estimate matrix. This assumes that all sounding frames are occurring well within the coherence time of the channel.

The following definitions are provided for purposes of this description.

Lmax is the maximum number of LTFs that a client or station (STA) can receive and process in a single sounding exchange. If Lmax=1, then the client has no “beamformee sounding capability” beyond a single beamformer transmitter. It is nonsensical that a beamformee sounding capable client has Lmax=1. For the beamformee capability to make sense, Lmax>1, since it is assumed that any beamformer has more than one antenna.

nRx is the number of receiver chains of the client.

nTx is the number of transmit chains of the AP (assumed to be 8 for the examples herein).

Hn is the channel state information (CSI) (“channel matrix”) feedback from the client at sounding exchange n.

The goal of the techniques presented herein is to sound as many transmit chains on the AP as possible to improve beamforming and multi-user multiple-input multiple-output (MU-MIMO) performance despite the limitations on the ability of the client to receive and process LTFs.

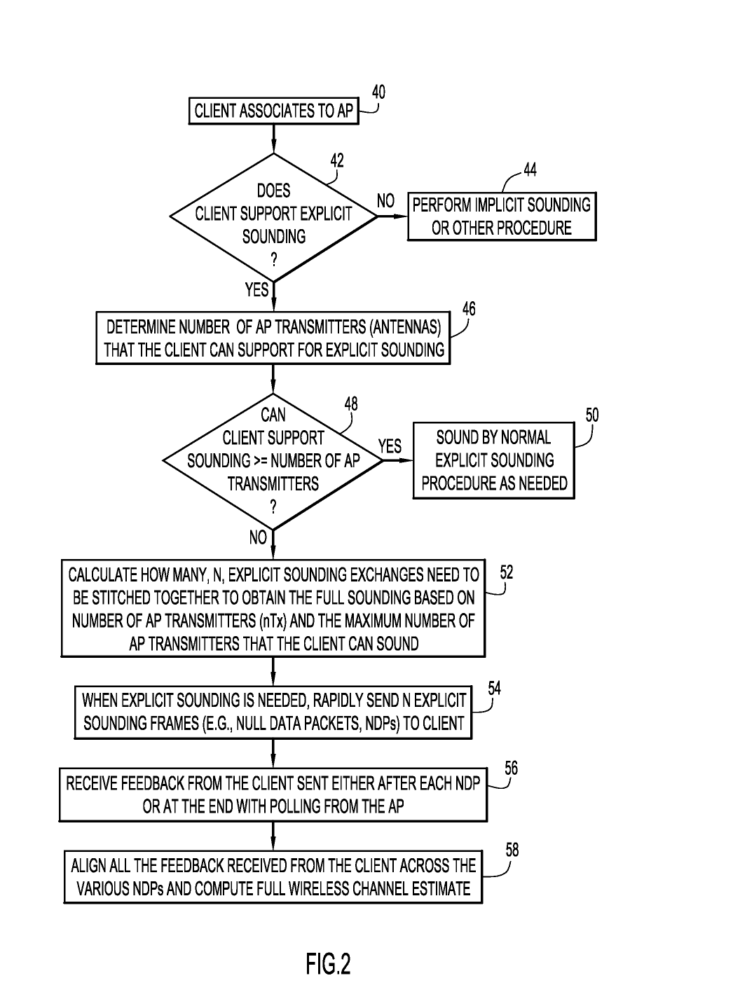

Turning now to FIG. 2, a flow chart is shown that depicts the sounding process according to these techniques. At 40, a client associates to the AP. The AP is fully aware of when a client associates to it, and at that point (or sometime later), needs to sound the channel between it and the client. At 42, the AP determines whether the client supports explicit sounding as a beamformee. The AP makes this determination based on the initial association message exchanges with the client. If the AP determines that the client does not support explicit sounding, then at 44, the AP performs implicit sounding or uses some other sounding procedure.

If the AP determines that the client supports explicit sounding, then at 46, the AP determines the number of AP transmitters (antennas) that the client can support for explicit sounding. This information is reported by the client to the AP during association, such as in the “Beamformee STS capability subfield in the VHT capabilities element” in accordance with the IEEE 802.11ac standard. It is also possible for the AP to send sounding frames with nTx antennas and analyze the dimensions of the feedback received from the client in order to determine the number of AP transmitters (antennas) that the client can support for explicit sounding. At 48, it is determined whether the client can support sounding of a number of antennas greater than or equal to the number of transmitters (antennas) on the AP. If the answer to the determination at 48 is yes, then at 50, the AP, when needed, sounds the channel using standard explicit sounding procedures, i.e., in accordance with IEEE 802.11n and/or 802.11ac. The number of AP transmitters (antennas) that the client can sound is denoted herein as “nTx_soundable”.

If it is determined at 48 that the client does not support sounding of a number of antennas greater than or equal to the number of transmitters (antennas) on the AP, then at 52, the AP calculates how many (referred to as “N”) explicit sounding exchanges need to be stitched/combined together to obtain the full sounding based on number (nTx) of AP antennas/transmitters and the maximum number of AP transmitters that the client can sound, nTx_soundable.

At 54, when explicit sounding is needed, the AP rapidly sends N explicit sounding frames (e.g., null data packets, NDPs) to the client. At 56, the AP receives the CSI matrix feedback from the client sent either after each NDP or at the end of all of the NDPs in response to polling from the AP. At 58, the feedback received from the client across the various NDPs is aligned and using the feedback, the AP computes the full wireless channel estimate for that client. The details of this computation are described hereinafter.

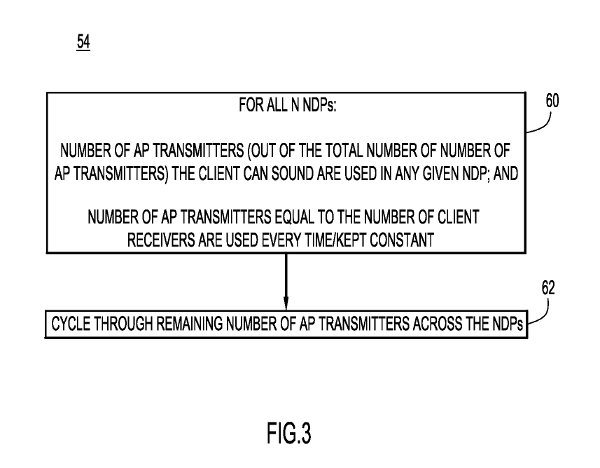

Turning to FIG. 3, the operation 54 is described in more detail. Specifically, at 60, for all N NDPs, nTx_soundable transmit chains of the AP (out of the full nTx) are used in any given NDP. Moreover, for all N NDPs, nRx_client AP transmit chains are used every time/kept constant. It is possible to keep more than nRx_client AP transmit chains constant across the NDPs, but not possible to use fewer. At 62, the remaining number of AP transmitters are cycled through across the many NDPs. Eventually, all transmitter (antennas) are used for sounding, and the transmitters (antennas) are chosen in a way that allows the received feedback to be assembled to construct the full wireless channel estimate matrix.

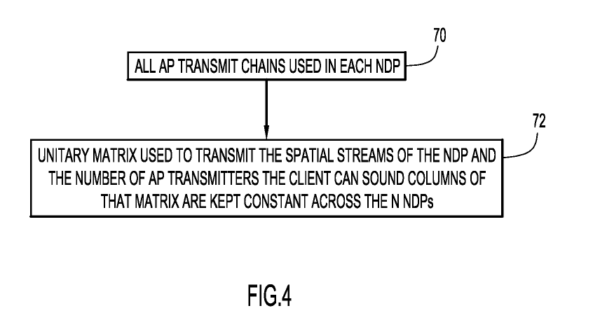

Turning now to FIG. 4, a variation to the procedure shown in FIGS. 2 and 3 is described. As shown at 70, all transmit chains of the AP are used in each NDP. At 72, a unitary matrix is used to transmit the spatial streams of the sounding frames. The unitary matrix has a number of rows equal to the number of antennas (nTx) and corresponding transmitters of the AP and a number of columns equal to the number of spatial streams being sent for a sounding frame (e.g., NDP). Moreover, the number of columns of the unitary matrix equal to the number of antennas and corresponding receivers at the client are kept constant across the (N) plurality of sounding frames. The computations to align together the information across the NDPs and remove the unitary matrix for this variation is different than that used for the procedure shown in FIGS. 2 and 3.

Thus, to summarize, in method form, a method is provided comprising: at a first device having a first plurality of antennas and corresponding transmitters, wirelessly transmitting a plurality of sounding frames to a second device having a second plurality of antennas and corresponding receivers, such that at least one of the first plurality of antennas is kept constant across the plurality of sounding frames; receiving at the first device from the second device at least one feedback message containing channel matrix information derived from reception of the sounding frames at the second plurality of antennas of the second device; deriving from the channel matrix information a full wireless channel estimate between the first plurality of antennas of the first device and the second plurality of antennas of the second device.

### Example 1

Consider the following example for determining CSI from feedback from an 802.11n client and 1×1 802.11n or 802.11ac steering matrix/compressed steering matrix (SM/cSM) feedback.

This can be used for all cases where nTx<Lmax. The number of required sounding frames, M, is dependent only on Lmax and nTx:

M=ceil((nTx-1)/(Lmax-1)),

where ceil( ) is a ceiling operation.

In CSI feedback, the full wireless CSI matrix estimate is fed back from the client to the AP. Therefore, no estimate of the left singular vectors is necessary and a single transmit chain can act as a reference across several sounding packets. That single reference antenna is used to remove phase and amplitude differences between multiple sounding frames to align the CSI matrices generated and fed back by the client for each of the received sounding packets.

If there are 3 sounding frames to sound the full channel and transmit chains 1 and 2 are set as the reference, that is, kept constant (only 1 transmit chain need be kept constant but 3 sounding frames are needed so having a second reference transmit chain helps reduce the impact of noise). The nRx=1 case is addressed for simplicity, but this procedure also works for nRx>1.

On the sounding packets, the AP transmitters are enabled as follows.

### Sounding Frame 1 Transmitter Mapping (Rows are Transmit Chains and Columns are Spatial Streams)

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ]$$

### Sounding Frame 2 Transmitter Mapping (Rows are Transmit Chains and Columns are Spatial Streams)

$$[ \begin{matrix}1 & 0 & 0 & 0 \\ 0 & 1 & 0 & 0 \\ 0 & 0 & 0 & 0 \\ 0 & 0 & 0 & 0 \\ 0 & 0 & 1 & 0 \\ 0 & 0 & 0 & 1 \\ 0 & 0 & 0 & 0 \\ 0 & 0 & 0 & 0\end{matrix} ]$$

### Sounding Frame 3 Transmitter Mapping (Rows are Transmit Chains and Columns are Spatial Streams)

$$[ \begin{matrix}1 & 0 & 0 & 0 \\ 0 & 1 & 0 & 0 \\ 0 & 0 & 0 & 0 \\ 0 & 0 & 0 & 0 \\ 0 & 0 & 0 & 0 \\ 0 & 0 & 0 & 0 \\ 0 & 0 & 1 & 0 \\ 0 & 0 & 0 & 1\end{matrix} ]$$

H1=alpha1*[a1b1c1d1]^{T}

H2=alpha2*[a2b2c2d3]^{T}

H3=alpha3*[a3b3c3d3]^{T}

where^{T} is the transpose operation.

Let alphaN be phase and amplitude on the Nth sounding frame channel estimation due to differences in frequency offset estimation, automatic gain control/receiver gain stages, and timing estimation. Since the first 2 transmitters were kept constant across the 3 sounding frames, then [a1 b1]=[a2 b2]=[a3 b3].

To obtain the estimate of the full nTx by nRx wireless channel H matrix, the Htot matrices across the Hn matrices are scaled and phase rotated into alignment with each other and then mapped to the relevant rows based on the transmit chain mapping during the sounding frame.

To remove alphaN from each Hn matrix, the first sounding frame's phase and amplitude is used as a reference and alpha2 and alpha3 are removed from H2 and H3 relative to H1:

Htot([1 2 3 4]:)=exp(sqrt(−1)*angle([a1b1]×[a1b1]^{H}))/sqrt(a1²+b1²)×H1

Htot([1 2 5 6]:)=exp(sqrt(−1)*angle([a1b1]×[a2b2]^{H}))/sqrt(a2²+b2²)×H2

Htot([1 2 7 8]:)=exp(sqrt(−1)*angle([a1b1]×[a3b3]^{H}))/sqrt(a3²+b3²)×H3

where^{H} is the Hermitian operation.

### Example 2

Consider another example involving an 802.11n client and 1×1 802.11n SM/cSM feedback and 802.11ac cSM feedback. This can be used for all cases where nRx<Lmax. The number of required sounding frames, M, is dependent on Lmax, nTx and nRx:

M=ceil((nTx−nRx)/(Lmax−nRx))

Since only the right singular vectors (by virtue of the feedback SM or cSM) and approximate singular values (by virtue of SNR feedback) are fed back in SM and cSM type explicit feedback, the left singular vectors of the channel need to be estimated. The nRx transmit chains are held constant across sounding packets (instead of just 1 as in the CSI feedback case). The same transmit chain mapping can be used from the 1×1/CSI feedback example (Example 1) for a 2×2 STA.

The processing of the Htot is slightly different.

Since H1, H2 and H3 are decomposed before feedback (only the Dn and Vn matrices are fed back), then:

H1=U1×D1×V1^{H}

H2=U2×D2×V2^{H}

H3=U3×D3×V3^{H}

where U and V are unitary matrices such that H=USV and S is a diagonal matrix with singular values.

To reconstruct Htot, the following is estimated

G1=U1×U1^{H}=identity matrix due to unitary matrix properties

G2=U1×U2^{H}=unitary due to unitary matrix properties

G3=U1×U3^{H}=unitary due to unitary matrix properties

since H1(1:nRx,1:nRx)˜=H2(1:nRx,1:nRx)˜=H3(1:nRx,1:nRx)

The approximation “˜=” is to say that the actual channel has not changed during the time of the multiple sounding frame exchanges (i.e. all sounding frames have been sent well within the channel coherence time). The nRx×nRx submatrix of the full channel matrix (the goal is to ultimately sound the full channel with multiple frames) is the part of the channel sounded on all frames, so it is the reference used to put the multiple sounding frame data back together for the full wireless channel matrix information.

Those matrices can be decomposed into further singular vectors and values and Htot reconstructed as:

[u1d1v1]=svd(D1(1:nRx,1:nRx)×V1(1:nRx,1:nRx)^{H})

[u2d2v2]=svd(D2(1:nRx,1:nRx)×V2(1:nRx,1:nRx)^{H})

[u3d3v3]=svd(D3(1:nRx,1:nRx)×V3(1:nRx,1:nRx)^{H})

where svd( ) is a singular value decomposition operation.

G2 and G3 have a closed form solution:

G1=Identity Matrix

G2=u1×d1×v1^{H}×v2×inv(d2)×u2^{H}

G3=u1×d1×v1^{H}×v3×inv(d3)×u3^{H}

Htot([1 2 3 4]:)=G1×H1([1 2 3 4]:)

Htot([5 6]:)=G2×H2([5 6:)

Htot([7 8]:)=G3×H3([7 8:)

This extends to nRx=3 and with the use of 5 sounding frames.

Again, the key is keeping at minimum nRx of the transmit chains common (constant) to all sounding packets and finding the matrix G2, G3, . . . that satisfies

$$D 1 ( 1 \text{:} nRx , 1 \text{:} nRx ) * V 1 ( 1 \text{:} nRx , 1 \text{:} nRx ) = G 2 * D 2 ( 1 \text{:} nRx , 1 \text{:} nRx ) * V 2 ( 1 \text{:} nRx , 1 \text{:} nRx ) = G 3 * D 3 ( 1 \text{:} nRx , 1 \text{:} nRx ) * V 3 ( 1 \text{:} nRx , 1 \text{:} nRx ) …$$

In a static wireless channel, those matrices are equal. In a dynamic wireless channel, they are approximately equal when the sounding exchanges are done well within the coherence time of the channel (so a minimum mean error solution also generally applies).

It is not necessary to solve for all of the Un's, but rather for the Un^{H}*U1. Common transmit chains from the first sounding exchange are used as a reference and the Gn is solved for that puts the remaining DnVn^{H} into alignment with D1V1^{H}.

For a single antenna client, this would simply be a phase rotation applied to D2V2^{H}, D3V3^{H}, to make a single reference transmit chain the same phase across all sounding exchanges. For the nRx>1 case, the phase rotation turns into a unitary matrix multiplication to accomplish the same across the multiple rows and columns of the channel matrix.

The derivation of finding Gn is based on the assumption that the common transmit chains across the many sounding exchanges should be equal. Finding the remaining Gn is done the same way with the corresponding Dn and Vn:

D1(1:nRx,1:nRx)*V1(1:nRx,1:nRx)^{H}=G2*D2(1:nRx,1:nRx)*V2(1:nRx,1:nRx)^{H}

To do so, it is necessary to right multiply both sides of the equation by the inverse of D2(1:nRx,1:nRx)*V2(1:nRx,1:nRx)^{H} to solve for G2. This cannot be done directly since the submatrix D2(1:nRx,1:nRx)*V2(1:nRx,1:nRx)^{H} is not necessarily invertible. First, it is necessary to decompose D2(1:nRx,1:nRx)*V2(1:nRx,1:nRx)^{H} by a SVD operation to make it invertible.

SVD of D2 yields Ua, Da and Va, which are all invertible. D2(1:nRx,1:nRx)*V2(1:nRx,1:nRx)^{H}=UaDaVa^{H}. Ua and Va simply need to be multiplied by their Hermitian to cancel out of the equation since they are unitary. Da is diagonal.

UaDaVa^{H}*Va*inv(Da)*Ua^{H}=Identity matrix

D1(1:nRx,1:nRx)*V1(1:nRx,1:nRx)^{H}*Va*inv(Da)*Ua^{H}=G2.

The same can be done for G3, G4, . . . for however many sounding exchanges are needed to sound all nTx transmit chains. Once all of the Gn are obtained, they are used to left multiply all of the Dn(1:nRx, 1:nRx)*Vn(nRx+1:end, 1:nRx)^{H} onto the same reference as D1*V1^{H}.

In the foregoing, H1/2/3 used is D1/2/3*(V1/2/3)^{H}, obtained from feedback from the client. Once again, the derivation below is for an example where nTx=8, Lmax=4 and nRx=2. In this scenario, nRx transmit chains would be kept the same through all sounding packets (transmit chains 1 and 2 are chosen for that in this example). One could keep more Tx chains common to all sounding exchanges but that has the potential to increase the number of exchanges needed. For example, 3 transmit chains could be kept constant/common while trying to sound a 2×2 client (instead of the minimum of 2 transmit chains), which would require 5 sounding exchanges to sound the full 8 transmit chains instead of 3. An example where increasing the number of transmit chains common across sounding frames does not increase the number of required exchanges is for nRx=1, nTx=8, nRx=4. If nRx=1, 3 sounding exchanges are needed to sound the full 8 transmit chains (it is possible to sound 7 transmit chains with 2 exchanges by keeping 1 common and cycling all the other antennas).

Htot([1 2 3 4]:)=G1×D1×V1^{H}

Htot(5:6:)=G2×D2(1:nRx,1:nRx)×V2(nRx+1:Lmax,1:nRx)^{H}

Htot(7:8:)=G3×D3(1:nRx,1:nRx)×V3(nRx+1:Lmax,1:nRx)^{H}

There is a tradeoff between the number of sounding frames and the number of sounded transmit chains. If for any reason, fewer sounding frames are preferred over fully sounding the channel, these techniques can be used to sound any number of transmit chains beyond Lmax with that tradeoff in mind. For example, if transmit chain sounding is relaxed to 7 transmit chains (instead of 8), only 2 sounding frames are needed instead of 3.

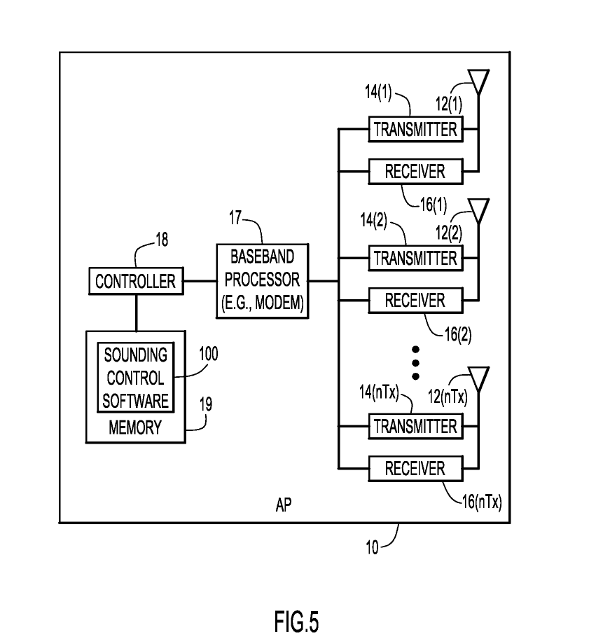

Turning now to FIG. 5, an example block diagram is shown of a device, e.g., AP 10, configured to perform the techniques presented herein. The device comprises a plurality of antennas 12(1)-12(nTx), a plurality of transmitters 14(1)-14(nTx), a plurality of receivers 16(1)-16(nTx), a baseband processor (e.g., a modem) 17, a controller 18 and a memory 19. The controller 18 controls various functions of the AP including the modem 17 and transmitters 14(1)-14(nTx) to perform the sounding procedures presented herein. To this end, executable instructions for sounding control software 100 are stored/encoded in the memory 19. The controller 18 is, for example, a microprocessor or microcontroller, and executes the sounding control software 100 to perform the sounding techniques and channel matrix computation techniques presented herein.

The memory 19 may comprise read only memory (ROM), random access memory (RAM), magnetic disk storage media devices, optical storage media devices, flash memory devices, electrical, optical, or other physical/tangible memory storage devices. In general, the memory 19 may comprise one or more tangible (non-transitory) computer readable storage media (e.g., a memory device) encoded with software comprising computer executable instructions and when the software is executed (by the controller 18) it is operable to perform the operations described herein.

Thus, in apparatus form an apparatus is provided comprising a first plurality of antennas of a first device; a plurality of transmitters, each associated with and coupled to a corresponding one of the first plurality of antennas; a plurality of receivers, each associated with and coupled to a corresponding one of the first plurality of antennas; a modem configured to be coupled to the plurality of transmitters and plurality of receivers, and to supply weighted versions of sounding frames to the plurality of transmitters for transmission to a second device having a second plurality of antennas and to process signals received at the first plurality of antennas from the second device; and a controller coupled to the modem, wherein the controller is configured to: cause the modem to apply a transmit matrix to a plurality of sounding frames to be transmitted to the second device so that at least one of the first plurality of antennas is kept constant across the plurality of sounding frames; cause the modem to receive from the second device at least one feedback message containing channel matrix information derived from reception of the sounding frames at the second plurality of antennas of the second device; and derive from the channel matrix information a full wireless channel estimate between the first plurality of antennas of the first device and the second plurality of antennas of the second device.

Similarly, provided herein is a tangible computer readable storage media (e.g., a memory device) encoded with software comprising computer executable instructions and when the software is executed operable to: at a first device having a first plurality of antennas and corresponding transmitters, cause a modem to apply a transmit matrix to a plurality of sounding frames to be transmitted via the first plurality of antennas from the first device to a second device having a second plurality of antennas so that at least one of the first plurality of antennas is kept constant across the plurality of sounding frames; cause the modem to receive from the second device at least one feedback message containing channel matrix information derived from reception of the sounding frames at the second plurality of antennas of the second device; and derive from the channel matrix information a full wireless channel estimate between the first plurality of antennas of the first device and the second plurality of antennas of the second device.

In summary, techniques are presented herein to explicitly sound the channel when a first device (e.g., an AP) has more antennas than a second device (e.g., a client) is capable of explicitly sounding. To do so, nRx number of columns of a transmit matrix are kept constant across the sounding frames (e.g., NDPs). This includes using an identity matrix type transmit vector (which is presented as an example herein and equates to keeping rows of the transmit matrix constant) and using the unitary transmit matrix which does not keep rows constant but does keep columns constant across the sounding frames (NDPs). The alternative to the techniques presented herein is to only be able to implicitly sound the channel, which can be unreliable because implicit sounding is dependent on uplink traffic.

The above description is intended by way of example only.

What is claimed is:

1. A method comprising:
at a first device having a first plurality of antennas and corresponding transmitters, wirelessly transmitting a plurality of sounding frames to a second device having a second plurality of antennas and corresponding receivers, such that at least one of the first plurality of antennas is kept constant across the plurality of sounding frames;
receiving at the first device from the second device at least one feedback message containing channel matrix information derived from reception of the sounding frames at the second plurality of antennas of the second device;
deriving from the channel matrix information a full wireless channel estimate between the first plurality of antennas of the first device and the second plurality of antennas of the second device.

2. The method of claim 1, wherein transmitting comprises transmitting the plurality of sounding frames with a single one of the first plurality of antennas kept constant across the plurality of sounding frames, and wherein receiving comprises receiving the feedback message comprising channel state information for the full wireless channel estimate.

3. The method of claim 1, wherein first device comprises nTx plurality of antennas and corresponding transmitters and the second device comprises nRx plurality of antennas and corresponding receivers, and wherein transmitting comprises transmitting the plurality of sounding frames with nRx out of nTx antennas of the first device kept constant across M sounding frames, wherein receiving comprises receiving information describing a channel matrix for each received sounding frame at the second device, and wherein deriving comprises scaling and phase rotating into alignment with each other the channel matrices for the received sounding frames and mapped to relevant rows of the full wireless channel estimate.

4. The method of claim 3, wherein transmitting comprises transmitting sounding frames comprising null data packets such that for all null data packets, the number of transmitters of the first device (out of the total number of number of transmitters of the first device) the second device can sound are used for any given null data packet, and the number of transmitters of the first device equal to the number of receivers of the second device are used for each null data packet, and further comprising cycling through remaining antennas and corresponding transmitters of the first device for transmission of null data packets.

5. The method of claim 1, further comprising:
determining the number of antennas and corresponding transmitters of the first device that the second device can support for explicit sounding;
determining whether the second device can support explicit sounding for the same or more than the number of antennas and corresponding transmitters of the first device; and
performing the transmitting, receiving and deriving when it is determined that the second device can support explicit sounding for less than the number of antennas and corresponding transmitters of the first device.

6. The method of claim 5, further comprising computing the number of explicit sounding exchanges need to be combined together to derive a full sounding based on the number of antennas and corresponding transmitters of the first device and the maximum number of antennas and corresponding of the first device that the second device can sound.

7. The method of claim 5, wherein transmitting comprises transmitting each of the plurality of null data packets with all of the plurality of antennas and corresponding transmitters of the first device, and with a unitary matrix having a number of rows equal to the number of antennas of the first device and a number of columns equal to the number of spatial streams being sent for a sounding frame, and wherein a number of columns of the unitary matrix equal to the number of antennas and corresponding receivers at the first device are kept constant across the plurality of sounding frames.

8. The method of claim 1, further comprising determining the number of sounding frames to transmit based at least on the number of antennas and corresponding transmitters of the first device and the maximum number of long training fields that the second device can receive and process in a single sounding exchange.

9. The method of claim 1, wherein the transmitting and receiving are performed in accordance with the explicit sounding procedures of the IEEE 802.11 communication standard.

10. An apparatus comprising:
a first plurality of antennas of a first device;
a plurality of transmitters, each associated with and coupled to a corresponding one of the first plurality of antennas;
a plurality of receivers, each associated with and coupled to a corresponding one of the first plurality of antennas;
a modem configured to be coupled to the plurality of transmitters and plurality of receivers, and to supply weighted versions of sounding frames to the plurality of transmitters for transmission to a second device having a second plurality of antennas and to process signals received at the first plurality of antennas from the second device; and
a controller coupled to the modem, wherein the controller is configured to:
cause the modem to apply a transmit matrix to a plurality of sounding frames to be transmitted to the second device so that at least one of the first plurality of antennas is kept constant across the plurality of sounding frames;
cause the modem to receive from the second device at least one feedback message containing channel matrix information derived from reception of the sounding frames at the second plurality of antennas of the second device; and
derive from the channel matrix information a full wireless channel estimate between the first plurality of antennas of the first device and the second plurality of antennas of the second device.

11. The apparatus of claim 10, wherein the controller is configured to cause the modem to transmit the plurality of sounding frames with a single one of the first plurality of antennas kept constant across the plurality of sounding frames, and to cause the modem to receive the feedback message comprising channel state information for the full wireless channel estimate.

12. The apparatus of claim 10, wherein the first device comprises nTx plurality of antennas and corresponding transmitters and the second device comprises nRx plurality of antennas and corresponding receivers, and wherein the controller causes the modem to transmit the plurality of sounding frames with nRx out of nTx antennas of the first device kept constant across M sounding frames, and to receive from the second device information describing a channel matrix for each received sounding frame at the second device, and wherein the controller is configured to derive the full wireless channel estimate by scaling and phase rotating into alignment with each other the channel matrices for the received sounding frames and mapped to relevant rows of the full wireless channel estimate.

13. The apparatus of claim 12, wherein the controller is configured to cause the modem to transmit sounding frames comprising null data packets such that for all null data packets, the number of transmitters of the first device (out of the total number of number of transmitters of the first device) the second device can sound are used for any given null data packet, and the number of transmitters of the first device equal to the number of receivers of the second device are used for each null data packet, and the controller is further configured to cause the modem to cycle through remaining antennas and corresponding transmitters of the first device for transmission of null data packets.

14. The apparatus of claim 10, wherein the controller is further configured to:
determine the number of antennas and corresponding transmitters of the first device that the second device can support for explicit sounding;
determine whether the second device can support explicit sounding for the same or more than the number of antennas and corresponding transmitters of the first device; and
cause the modem to apply the transmit matrix, receive the at least one feedback message and to derive the full wireless channel estimate when it is determined that the second device can support explicit sounding for less than the number of antennas and corresponding transmitters of the first device.

15. The apparatus of claim 14, wherein the controller is configured to compute the number of explicit sounding exchanges to be combined together to derive a full sounding based on the number of antennas and corresponding transmitters of the first device and the maximum number of antennas and corresponding transmitters of the first device that the second device can sound.

16. One or more computer readable storage media encoded with software comprising computer executable instructions and when the software is executed operable to:
at a first device having a first plurality of antennas and corresponding transmitters, cause a modem to apply a transmit matrix to a plurality of sounding frames to be transmitted via the first plurality of antennas from the first device to a second device having a second plurality of antennas so that at least one of the first plurality of antennas is kept constant across the plurality of sounding frames;
cause the modem to receive from the second device at least one feedback message containing channel matrix information derived from reception of the sounding frames at the second plurality of antennas of the second device; and
derive from the channel matrix information a full wireless channel estimate between the first plurality of antennas of the first device and the second plurality of antennas of the second device.

17. The computer readable storage media of claim 16, wherein the first device comprises nTx plurality of antennas and corresponding transmitters and the second device comprises nRx plurality of antennas and corresponding receivers, and further comprising instructions that are operable to:
cause the modem to transmit the plurality of sounding frames with nRx out of nTx antennas of the first device kept constant across M sounding frames;
receive from the second device information describing a channel matrix for each received sounding frame at the second device; and
derive the full wireless channel estimate by scaling and phase rotating into alignment with each other the channel matrices for the received sounding frames and mapped to relevant rows of the full wireless channel estimate.

18. The computer readable storage media of claim 16, further comprising instructions operable to:
determine the number of antennas and corresponding transmitters of the first device that the second device can support for explicit sounding;
determine whether the second device can support explicit sounding for the same or more than the number of antennas and corresponding transmitters of the first device; and
cause the modem to apply the transmit matrix, receive the at least one feedback message and derive the full wireless channel estimate when it is determined that the second device can support explicit sounding for less than the number of antennas and corresponding transmitters of the first device.

19. The computer readable storage media of claim 18, further comprising instructions operable to compute the number of explicit sounding exchanges to be combined together to derive a full sounding based on the number of antennas and corresponding transmitters of the first device and the maximum number of antennas transmitters of the first device that the second device can sound.

20. The computer readable storage media of claim 18, further comprising instructions operable to cause the modem to transmit each of the plurality of null data packets with all of the plurality of antennas and corresponding transmitters of the first device, and with a unitary matrix having a number of rows equal to the number of antennas of the first device and a number of columns equal to the number of spatial streams being sent for a sounding frame, and wherein a number of columns of the unitary matrix equal to the number of antennas and corresponding receivers at the first device are kept constant across the plurality of sounding frames.
